(19) United States
(12) Patent Application Publication
(10) Pub. No.: US 2011/0209731 A1
(43) Pub. Date: Sep. 1, 2011

(54) EQUIPMENT FOR CLEANING CONTAINERS

(75) Inventor: Patrick Mie, Octeville-Sur-Mer (FR)

(73) Assignee: SIDEL PARTICIPATIONS, Octeville-Sur-Mer (FR)

(21) Appl. No.: 13/127,388

(22) PCT Filed: Nov. 2, 2009
(86) PCT No.: PCT/FR09/52109

§ 371 Date: May 3, 2011

(30) Foreign Application Priority Data
Nov. 4, 2008 (FR) 08 57485

(51) Int. Cl. B08B 9/00

(52) U.S. Cl. 134/171

(57) ABSTRACT

The invention relates to equipment consisting of a stationary base (2) to which a rotary frame (3) is attached, which includes: on the one hand, means for supporting the containers (1) to be cleaned, on the other hand, in correlation with said containers (1), insufflation tubes (4) forming the rods of cylinders (6), suitable for being inserted, on the fly, into the correlating containers. The insufflation tubes comprise a ring (15) the travel of which is adjustable by means of abutments (16) arranged on a plate. Said plate-abutment (16), shared by all the insufflation tubes (4), can be controlled by means of a screw (17) and nut (18) system or by any other means, to adjust the position of the nozzles (9) located at the end of said tubes (4) to adapt said position according to the size of the containers (1).

### FIELD OF THE INVENTION

The present invention relates to an installation for cleaning containers of the flask and bottle type, and more particularly containers of the preforms type used for shaping bottles and other elements made of thermoplastic.

### DESCRIPTION OF THE PRIOR ART

This type of installation, which is the subject of documents WO 99/03513 and DE 10140906, makes it possible to clean and, as appropriate, sterilize the preforms that are intended for manufacturing, by blow molding or by stretch-blow molding, containers made of thermoplastic. This type of installation is also used for cleaning bottles such as, for example, bottles that have received after molding a particular treatment intended to produce an internal coating deposit which enhances, in particular, the sealing of the wall. The installation comprises several cleaning stations fitted with a tube for insufflating a pressurized gas and this insufflation tube is subjected to a raising and lowering cycle in order to enter the corresponding bottle which is inverted over said tube.

The raising and lowering movement of the insufflation tube is carried out by means of a cam and roller system with a cam that is fixed and a roller that is secured to the guide carriage of the insufflation tube.

This cam system makes it possible to position precisely the nozzle situated at the end of the insufflation tube relative to the bottom of the bottle. However, both for the bottles and for the bottle performs, it is common for this type of installation to produce series of products with variable dimensions.

In the case of the aforementioned installation, for rinsing the bottles, the change of format of the bottles requires a change of the cam which allows the operation of the insufflation tube. In reality, for minor variations of format, the cam is not changed and variations in the level of the cleaning result are observed because the optimum distance between the nozzle and the bottom of the bottle is not achieved.

These variations in the level of the cleaning result are frequent and are a direct result of the difficulties in changing this cam and of the time saved by avoiding changing it.

Another type of installation, as described in document EP 588 134, makes it possible to clean bottles and, in particular, also to effectively clean the neck. This cleaning is carried out by means of a nozzle that is wedged for the cleaning of the neck and that is then operated by a cylinder of the single-acting type in order to clean the inside of the bottle. However, the nozzle and the cylinder are not arranged to treat the bottoms of the containers and in particular to carry out a treatment that will be ensured by an optimum distance between the bottom and the nozzle, irrespective of the format of said containers.

### SUMMARY OF THE INVENTION

The present invention proposes an installation for cleaning containers of the preforms type and/or bottles or other elements, which makes it possible to overcome the drawbacks of the aforementioned installations. The installation according to the invention allows the operator to adjust his machine and, in particular, to simultaneously adjust the position that the various insufflation nozzles must occupy relative to the bottom of the container to be cleaned. This adjustment is carried out by a simple, fast and effective operation which makes it possible at all times to ensure an optimum cleaning of said preforms, bottles or other elements.

A further object of the invention is to simplify this type of installation, notably in the distribution of the pipes and tubes that are used to carry the cleaning fluid and the compressed air with enhancements relating to reducing pressure losses.

Moreover, the installations of the cam type comprise many moving parts with slider systems for each cleaning station. The object of the present invention is also to reduce the number of moving parts and to simplify the construction of the systems for guiding the insufflation tubes.

The installation according to the invention consists of a fixed base on which is installed a rotary frame which comprises:
on the one hand, means for supporting the containers to be cleaned,
on the other hand, in correspondence with these containers, insufflation tubes which are each manipulated by appropriate means, of the cylinder type, in order to be inserted, on the fly, into the corresponding containers,
   which means for inserting said insufflation tubes into said containers consist of cylinders which each comprise a hollow rod serving as an insufflation tube, which rod extends between a cleaning fluid inlet and, on the other hand, the nozzle which sprays said fluid into and onto the bottom of the container to be cleaned.

Still according to the invention, the installation comprises means that make it possible to simultaneously adjust the travel of the various rods of cylinders, which serve as insufflation tubes, which means are loaded onto the rotary frame.

According to a first embodiment, the means for adjusting the travel of the rod of the cylinders consist of a ring placed on the free end of the rod, on the side of the cleaning fluid inlet, and of an abutment the position of which can be adjusted under the effect of appropriate means in order to establish and limit the travel of said ring and to position the cleaning nozzle at a chosen distance, relative to the bottom of the container to be cleaned.

Still according to the invention, the abutments are distributed over a structure in the form of a plate, which plate is operated by means of a screw and nut and/or rack and pinion system, in order to adjust its position as required relative to the rotary frame.

According to a variant embodiment, the means for simultaneous adjustment of the rods of cylinders are placed directly on the structure for supporting the various cylinders in order to axially move said structure for supporting the cylinders and place the base of each cylinder rod, the piston of which serves as a wedging ring and in which the mouth of the cylinder serves as an abutment, at a chosen distance relative to the bottom of the corresponding container.

Still according to the invention, and for this second embodiment, the system for adjusting the distance between the nozzle and the bottom of the container also consists of a screw and nut and/or rack and pinion system interposed between the rotary frame and the structure for supporting cylinders.

According to another arrangement of the invention, the means for operating the adjustment system are actuated either manually or by means of a programmable controller which manages notably the information of a device for automatically reading the height of the containers in order to adjust the distance between the nozzle and the bottom of said containers.

Still according to the invention, each cylinder rod comprises, on the side of the cleaning nozzle, a bell element capable of sliding on said rod by means of a tight guide in order to cap the opening of the container, which bell element is connected to a device of the aspirator type in order to allow the collection of dirt and other elements that are cleared away and propelled from the bottom of the container by the cleaning fluid.

According to another arrangement of the invention, the installation comprises a central unit for supplying pressurized fluid of the compressed air type, which fluid feeds both the cleaning nozzles and the various pneumatic cylinders through their respective actuation members.

According to another arrangement of the invention, the installation comprises cylinders of the single-acting type, the rod of which is placed in the active cleaning position under the effect of an elastic member of the spring type and the return, to the inactive position, is carried out by compressed air.

Still according to the invention, the various fluids flow between the base and the rotary frame via a rotary distributor.

According to a variant embodiment, the installation comprises a dual fluid feed:
a feed for applying the cylinders, with compressed air, and
a separate feed with a fluid, compressed air or other fluid, specially appropriate for cleaning the containers.

### BRIEF DESCRIPTION OF THE DRAWINGS

But the invention will be explained in further detail with the aid of the following description and of the appended drawings, given as an indication and in which:

FIG. 1 is a partial schematic view of the installation according to the invention with the nozzle in the active cleaning position,

FIG. 2 is a schematic view of the cylinder and of the container, with the cleaning nozzle in the inactive position,

FIG. 3 represents a variant embodiment of the installation.

### DETAILED DESCRIPTION OF THE INVENTION

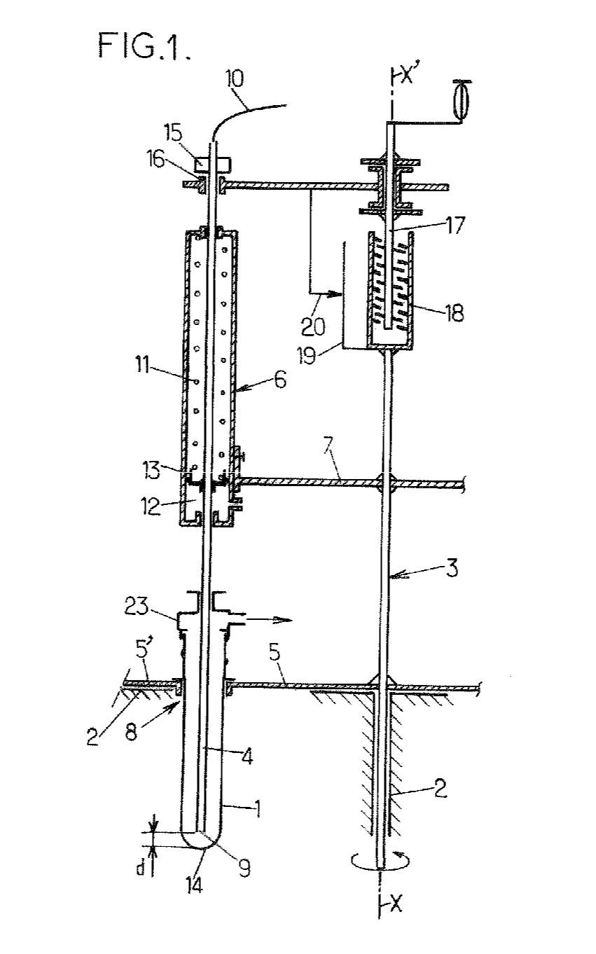

The installation shown schematically and partially in FIG. 1 relates to the cleaning of preforms 1; it makes it possible to clean said preforms 1 in order to remove the dust therefrom before they are inserted into the heating oven for example.

This installation comprises a base 2 which is fixed and which supports a rotary frame 3 on which there are, on the one hand, the preforms 1 and, on the other hand, cleaning tubes 4 which axially enter the corresponding preform 1.

The installation is fed evenly with preforms by appropriate means, which preforms 1 are installed in a structure which comprises, for example, a wheel 5 of the notched type. This wheel 5 is secured to the rotary frame 3 and it rotates in front of a guide 5′ that is fixed, secured to the base 2.

These preforms 1 may also be held in different ways, by means of grips, for example, not shown, supported by arms or a plate secured to the frame 3.

On their journey in the installation, these preforms 1 are positioned parallel to the axis X-X′ of the frame 3.

Each tube 4 for insufflating the cleaning fluid into the preforms 1 can be moved parallel to the axis X-X′ in order to enter and exit said preforms.

Each tube 4 forms part of a cylinder 6; it forms the movable rod of said cylinder 6 and in particular a rod that is of the through type.

This cylinder 6 is supported by a structure in the form of a platform 7 which forms part of the rotary frame 3 and this platform 7 actually comprises a multitude of cylinders 6 which are distributed over its whole periphery.

Each cylinder 6 corresponds with an emplacement 8 for receiving the preforms 1, which emplacements being placed on the wheel 5.

The insufflation tube 4 comprises, at one of its ends, the cleaning nozzle 9 and, at its other end, a flexible pipe 10 made of material of the type known as “RILSAN”, which carries the cleaning fluid.

The cylinder 6 is a pneumatic cylinder of the single-acting type. It is placed in the active cleaning position automatically by means of an internal elastic member in the form of a spring 11 and it is returned to the inactive position by the injection of compressed air into the chamber 12 which is opposite to the chamber containing the spring 11. The spring 11 rests on the piston 13 of the cylinder, which piston is secured to the cleaning tube 4 which serves as a rod for said cylinder 6.

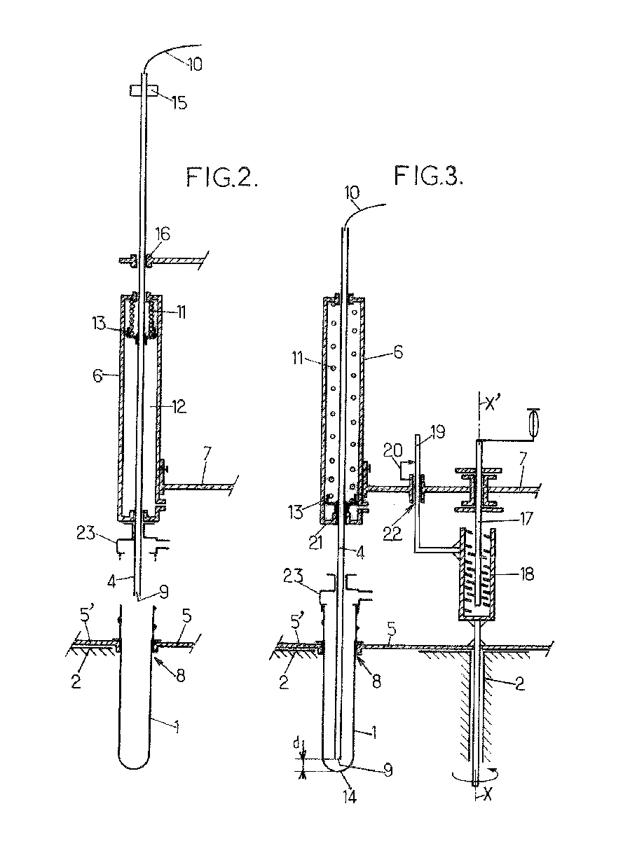

FIG. 2 shows the insufflation tube 4 in the inactive position with the spring 11 compressed under the effect of the pressure of the compressed air injected into the chamber 12 of the cylinder 6.

With the tube 4 in this retracted position, the preform 1 can be disengaged from the plate 5 and be picked up by appropriate means to enter the heating oven.

According to the dimension of the preform 1, the travel of the insufflation tube 4 can be adjusted, in the axis of said preform, in order to maintain a distance d between the nozzle 9 situated at the end of said tube 4 and the bottom 14 of the preform 1.

According to a first embodiment, shown in FIGS. 1 and 2, the insufflation tube 4 comprises, at its free end, on the side of the cleaning fluid inlet, a ring 15 which forms a sort of shoulder at the end of said tube.

The insufflation tube 4 is positioned by means of this ring 15 and of an abutment 16 which takes the form of a plate, which plate is common for all the insufflation tubes 4 and in particular to all the rings 15 placed on said tubes 4.

This plate-abutment 16 can be moved vertically in order to vary the travel of all of the insufflation tubes 4. It can be moved along the axis X-X′ of the frame 3 by means, for example, of a screw 17 and nut 18 system which can be manipulated directly by an operator.

It is possible to use any other means for operating the plate-abutment 16 relative to the frame 3 such as, for example, a rack and pinion system.

This plate-abutment 16 is loaded in rotation onto the frame 3 just like the system for adjusting its position.

The position of the plate-abutment may also be adjusted by means of a programmable controller which, for example, takes account of the information originating from a device for automatically reading and/or for recognizing shape, capable of giving the dimension of the preforms 1 to be cleaned.

In the case of a purely mechanical system that can be accessed directly by the operator, the latter may also have, in order to make his adjustment, a scaled ruler 19, secured to the frame 3, and a pointer 20 which is supported by the plate-abutment 16, for example.

According to a second embodiment, shown schematically in FIG. 3, the ring used to limit the travel of the insufflation tube 4 consists of a piston 13 of the cylinder 6. This piston 13, when the tube 4 is in the active cleaning position, butts against the mouth 21 of the cylinder 6. The travel of the tubes 4 is adjusted then by an adjustment of the position of all the cylinders 6 relative to the frame 3.

The cylinders 6 operate in an on-off way: in the active position, the piston 13 that is associated with the rod 4 of the cylinder 6 is in abutment against the mouth 21 of the latter and, in the inactive position, said piston 13 is also in abutment at the other end of said cylinder 6 by means of the spring 11.

The various cylinders 6 are supported by the structure 7 in the form of a plate and this structure 7 is centered and guided by means of a system of the slider(s) type 22 secured to the frame 3 in order to keep all the cylinders 6 in axial correspondence with the emplacement 8 of the preforms 1.

An operating mechanism, of the screw 17 and nut 18 type, as above, makes it possible to move axially, along the axis x-x′, the plate 7 supporting the cylinder and it makes it possible to adjust the travel of the insufflation tube 4 as required in order to establish the desired distance d between the nozzle 9 and the bottom 14 of the preform to be cleaned.

As above, the mechanism for operating the plate 7 may also be controlled manually or by means of a programmable controller, not shown, which takes account of the information given automatically or not relating to the dimension of the preform 1 to be cleaned or of any other object, such as, for example, bottles.

As above, for a manual adjustment, the operator may have a scaled ruler 19 installed, for example, on the slider 22 and a pointer 20 making it possible to read the position of the plate 7 directly in order to establish an appropriate distance d between the nozzle 9 and the bottom 14 of the preform 1.

Also shown in the various figures is an aspiration bell element 23 that is installed on the insufflation tube 4 between the nozzle 9 and the cylinder 6. This bell element 23 is mounted so as to slide on the insufflation tube 4 with a guide of the tight type. When the tube 4 passes from its inactive position to its active cleaning position, it carries the bell element 23 which is positioned automatically on the opening of the preform 1 without hampering the movement of the tube 4. This bell element 23 is connected to an aspiration device not shown in order to clear away the dust that has been removed and ejected through the cleaning nozzle 9.

When the insufflation tube 4 travels from its active cleaning position to its inactive position, it again carries the bell element 23 which stops on the mouth 21 of the cylinder without disrupting the movement of said tube 4.

The injection of the cleaning fluid, of the compressed air and the aspiration of dust and other elements in the bell element 23 are carried out by means of a rotating seal, not shown, placed between the base 2 and the rotary frame 3.

1.-11. (canceled)

12. An installation for cleaning containers consisting of a fixed base on which is installed a rotary frame which comprises:
on the one hand, means for supporting said containers to be cleaned,
on the other hand, in correspondence with these containers, insufflation tubes which are each manipulated by appropriate means, of the cylinder type, in order to be inserted, on the fly, into the corresponding containers,
wherein the means for inserting the insufflation tubes into said containers consist of cylinders which each comprise a hollow rod serving as an insufflation tube, which rod extends between a cleaning fluid inlet and, on the other hand, the nozzle which sprays said fluid into and onto the bottom of the container to be cleaned.

13. The installation for cleaning containers as claimed in claim 12, wherein it comprises means that make it possible to simultaneously adjust the travel of the various rods of cylinders, which serve as insufflation tubes, which means are loaded onto the rotary frame.

14. The installation for cleaning containers as claimed in claim 13, wherein it comprises means for adjusting the travel of the rod of the cylinders which consist of a ring placed on the free end of said rod, on the side of the cleaning fluid inlet, and of an abutment the position of which can be adjusted under the effect of appropriate means in order to establish and limit the travel of said ring and to position the cleaning nozzle at a chosen distance d, relative to the bottom of the container to be cleaned.

15. The installation for cleaning containers as claimed in claim 14, wherein it comprises abutments distributed over a structure in the form of a plate, which plate is operated by means of a screw and nut or other system, in order to adjust its position relative to the frame.

16. The installation for cleaning containers as claimed in claim 13, wherein it comprises means for simultaneous adjustment of the rods of cylinders, which means consist of the structure for supporting said cylinders, which structure comprises means, of the slider type, interacting with the frame, allowing an axial movement relative to said frame, each cylinder operating in an on-off manner: in the active position, the piston associated with the rod of the cylinder is in abutment on the mouth of the latter and, in the inactive position, said piston is also in abutment.

17. The installation for cleaning containers as claimed in claim 16, wherein it comprises means for operating the structure for supporting cylinders, consisting of a screw and nut system interposed between said structure for supporting cylinders and the frame.

18. The installation for cleaning containers as claimed in claim 14, wherein it comprises means for operating the system for adjusting the nozzles which consist of a programmable controller which manages information originating from a device for automatically reading the height of the containers, which programmable controller makes it possible to adjust the distance between said nozzle and the bottom of said containers.

19. The installation for cleaning containers as claimed in claim 12, wherein it comprises, on each insufflation tube, on the side of the cleaning nozzle, a bell element capable of sliding on said tube and of capping the opening of said container, which bell element is connected to a device of the aspirator type for collecting the dirt and other elements that are cleared away by the nozzle and the cleaning fluid.

20. The installation for cleaning containers as claimed in claim 12, wherein it comprises a central unit for supplying pressurized fluid of the compressed air type, which fluid feeds both the cleaning nozzles and the various pneumatic cylinders through their respective actuation members.

21. The installation for cleaning containers as claimed in claim 20, wherein it comprises cylinders of the single-acting type, the rod of which is placed in the active cleaning position under the effect of an elastic member of the spring type and, in the inactive position, by application of compressed air.

22. The installation for cleaning containers as claimed in claim 12, wherein it comprises a dual fluid feed:
a feed for applying the cylinders, with compressed air and
a separate feed with a cleaning fluid, compressed air or other fluid, specially appropriate for the type of container such as, for example, preforms.
